(19) United States
(12) Patent Application Publication
(10) Pub. No.: US 2025/0389952 A1
(43) Pub. Date: Dec. 25, 2025

(54) AUTOMATED PARTICLE REMOVAL METHOD AND SYSTEM

(71) Applicant: ASMPT Singapore Pte. Ltd., Singapore (SG)

(72) Inventors: Wai Lam WONG, Hong Kong (CN); Xiao Dong LAN, Chengdu (CN); Ying San CHUI, Hong Kong (CN); Li Dong HE, Chengdu (CN); Po Lam AU, Hong Kong (CN)

(21) Appl. No.: 19/226,581

(22) Filed: Jun. 3, 2025

(30) Foreign Application Priority Data
Jun. 20, 2024 (CN) 202410804124.9

(51) Int. Cl. G02B 27/00; B08B 7/00; G01N 21/94

(52) U.S. Cl. CPC G02B 27/0006; B08B 7/0028; G01N 21/94

(57) ABSTRACT

A method for removing foreign particles from an object having a bonding surface includes the steps of arranging the object at a pick-up station and picking up the object with a movable picking device with the bonding surface of the object facing downwards; moving the object to an inspection position with the movable picking device and inspecting the bonding surface with a vision system located below the inspection position to identify whether any foreign particles are present on the bonding surface and to determine positions of the foreign particles on the bonding surface, and contacting each foreign particle with a particle removal tool at the determined position of the respective foreign particle in order to remove it while the bonding surface is facing downwards.

### FIELD OF THE INVENTION

The invention generally relates to the removal of foreign particles from a bonding surface, and more specifically to an automated method and system for removing foreign particles from a surface of an object that is to be bonded and is arranged facing downwards, e.g., a surface of a lens holder that is to be bonded to an image sensor.

### BACKGROUND

In the assembly of complementary metal oxide semiconductor (CMOS) image sensor (CIS) camera modules, foreign particles should be removed from the bonding surfaces of the CMOS sensor and the lens holder to ensure high camera image quality. Various methods have been proposed for cleaning the bonding surface of the CMOS sensor while the bonding surface is arranged facing upwards during the cleaning process.

However, when it comes to the bonding surface of the lens holder that is arranged facing downwards, particle removal is typically achieved by directing filtered air, ionized air, or plasma onto the bonding surface to eliminate foreign particles. One concern with these existing particle removal methods is that foreign particles on the bonding surface of the lens holder may not be effectively removed, with the result that the bonding surface would not be suitable for the subsequent bonding process as bonding defects may arise.

It would therefore be beneficial to provide an improved particle removal solution for removing foreign particles from a bonding surface of an object that is arranged facing downwards.

### SUMMARY OF THE INVENTION

It is thus an object of the invention to seek to provide an effective method and system for removing foreign particles from a bonding surface of an object, which is arranged facing downwards, e.g., a bottom surface of a lens holder that is to be bonded to a top surface of a CMOS sensor.

According to a first aspect of the present invention, there is provided an automated method for removing foreign particles from a bonding surface of an object. The method comprises the steps of arranging the object at a pick-up station and picking up the object from the pick-up position with a movable picking device with the bonding surface of the object facing downwards, moving the object to an inspection position with the movable picking device and inspecting the bonding surface with a vision system located below the inspection position to identify whether any foreign particles are present on the bonding surface and to determine positions of the foreign particles on the bonding surface, and contacting each foreign particle with a particle removal tool at the determined position of the respective foreign particle to remove it from the bonding surface while the bonding surface is facing downwards. The vision system is an up-look vision system which may include an up-look optical device.

To remove the foreign particles on the bonding surface of the object, the particle removal tool may include a gel stick having a sticky tip portion facing upwards. In one embodiment, the object may include a lens holder supporting a lens. The lens holder has a bonding surface that is arranged facing downwards and is to be bonded to a bonding surface of an image sensor that is arranged facing upwards.

After the particle removal process described above, the method may further include a step of conducting a post-cleaning inspection on the bonding surface with the vision system to determine whether the bonding surface meets a predetermined cleaning requirement before undergoing a subsequent bonding process. The predetermined cleaning requirement may include a number and/or size of the foreign particles should be less than predetermined values. If the bonding surface does not meet the predetermined cleaning requirement, the object will not be used in the subsequent bonding process and is to be transferred to a reject bin for storing rejected objects. If the bonding surface satisfies the predetermined cleaning requirement, the object is to be transferred to a bonding station for bonding with the movable picking device.

After the particle removal process or after determining the bonding surface meets the predetermined cleaning requirement through the post-cleaning process, the method may further include a step of conducting a position alignment between the lens holder and the vision system with the vision system.

To improve the efficiency of the particle removal process, the method may further include a step of applying a fluid with a cleaning device to the bonding surface of the object to remove foreign particles from the bonding surface before the object is picked up from the pick-up station by the movable picking device.

To pick the object with the movable picking device accurately, the method may further include a step of aligning the movable picking device with the object when the object is positioned on the pick-up station using a first optical system located above the pick-up station, prior to picking up the object with the movable picking device. The first optical system may include a down-look optical device.

To accurately remove the foreign particles with the particle removal tool, the method may further include a step of aligning each foreign particle on the bonding surface of the object held by the movable picking device relative to a sticky tip portion of the particle removal tool using a second optical system located above the particle removal tool, prior to removing each foreign particle from the bonding surface. The second optical system may include a down-look optical device.

To ensure the effectiveness of the particle removal process, the method may further include a step of replacing the particle removal tool with a new particle removal tool and adjusting a position of the new particle removal tool using the second optical system based on a predetermined reference position of the particle removal tool.

To improve the accuracy and efficiency of the vision system for inspecting the bonding surface of the object that is held by the movable picking device, the method may further include a step of calibrating a positional relationship between the vision system and the movable picking device prior to using the vision system for inspection. Specifically, the method includes the steps of identifying a known pattern on a calibration object that is held by the movable picking device with the vision system, monitoring or ascertaining positional changes of the known pattern as the movable picking device moves to a plurality of predetermined positions relative to the vision system and mapping a relationship between positions of the object relative to positions of the movable picking device based on the ascertained positional changes for accurately determining the positions of the foreign particles on the bonding surface.

To improve the accuracy and efficiency of the second optical system for aligning the foreign particle on the bonding surface with the sticky tip portion of the particle removal tool, the method may further include a step of calibrating a positional relationship between the second optical system and the movable picking device. Specifically, the method includes the steps of identifying a known pattern on a calibration object that is held by the movable picking device with the second optical system, monitoring and ascertaining positional changes of the known pattern as the movable picking device moves to a plurality of predetermined positions relative to the second optical system and mapping a relationship between positions of the object relative to positions of the movable picking device based on the ascertained positional changes for accurately contacting each foreign particle on the bonding surface with the particle removal tool.

To facilitate the calibration process, the calibration object may include a transparent material on which the known pattern is formed. In one embodiment, the calibration object includes a calibration glass. Further, the same calibration object with the known pattern may be used for the above two calibration processes.

Once the positional relationships between the movable picking device and the first and second optical systems are established, the first and second optical systems can co-relate to each other to align the sticky tip of the particle removal tool with the foreign particles on the bonding surface.

The movable picking device may comprise a bond head having an opening comprising a hollow through-hole along its longitudinal axis. This hollow through-hole can facilitate the calibration between the movable picking device and the second optical system that includes a down-look optical system.

According to a second aspect of the present invention, there is provided a system for removing foreign particles from an object having a bonding surface. The system includes a pick-up station on which the object is arranged, a movable picking device configured and operative to pick up the object from the pick-up station with the bonding surface of the object facing downwards and to move the object to an inspection position, a vision system located below the inspection position to inspect the bonding surface of the object that is held by the movable picking device to identify whether any foreign particles are present on the bonding surface and to determine positions of the foreign particles on the bonding surfaces, and a particle removal tool configured to contact each foreign particle on the bonding surface at the determined position of the respective foreign particle to remove it from the bonding surface while the bonding surface is facing downwards.

The particle removal tool may include a gel stick having a sticky tip portion facing upwards. In one embodiment, the particle removal tool may be fixedly located at a cleaning position such that the object is moved by the movable picking device to allow the sticky tip portion of the particle removal tool to contact each foreign particle on the bonding surface to remove it. Alternatively, in some embodiments of the invention, the particle removal tool may be movable relative to the bonding surface held by the movable picking device to remove the foreign particles on the bonding surface.

To enable a down-look optical system to inspect the object held or to be held by the movable picking device, the movable picking device may comprise a bond head having an opening comprising a hollow through-hole along the longitudinal axis of the bond head.

The vision system includes an up-look optical system. The vision system may be further configured to conduct a position alignment between the lens holder and the vision system. Specifically, the position alignment between the lens holder and the vision system may refer to aligning the center of the lens holder with the center of the vision system.

The system may further include a cleaning device located below a surface of the pick-up station to apply a fluid through an opening on the surface to the bonding surface of the object to remove foreign particles from the bonding surface when the object is arranged on the surface of the pick-up station with its bonding surface facing downwards.

These and other features, aspects, and advantages will become better understood with regard to the description section, appended claims, and accompanying drawings.

### BRIEF DESCRIPTION OF THE DRAWINGS

Embodiments of the present invention will now be described, by way of example only, with reference to the accompanying drawings, in which:

FIGS. 1A to 1E illustrate steps of a method for removing foreign particles from a bonding surface of a lens holder with a system as shown in FIGS. 1A to 1E according to one embodiment of the invention.

FIG. 2A is a side view of a gel stick holder according to one embodiment of the invention.

FIG. 2B illustrates a step of determining a position of a sticky tip portion of a gel stick using a second optical system according to one embodiment of the invention.

FIG. 3A illustrates a calibration process conducted between a picking device and a vision system for inspecting the bonding surface of the lens holder that is held by the picking device according to one embodiment of the invention.

FIG. 3B illustrates a calibration process conducted between the picking device and a second optical system for removing foreign particles from the bonding surface with a particle removal tool according to one embodiment of the invention.

In the drawings, like parts are denoted by like reference numerals.

### DETAILED DESCRIPTION OF THE PREFERRED EMBODIMENTS OF THE INVENTION

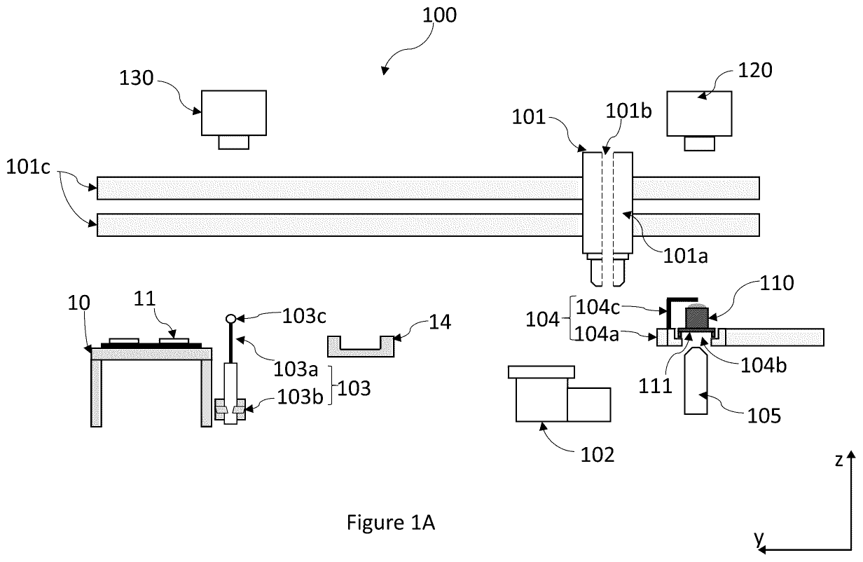

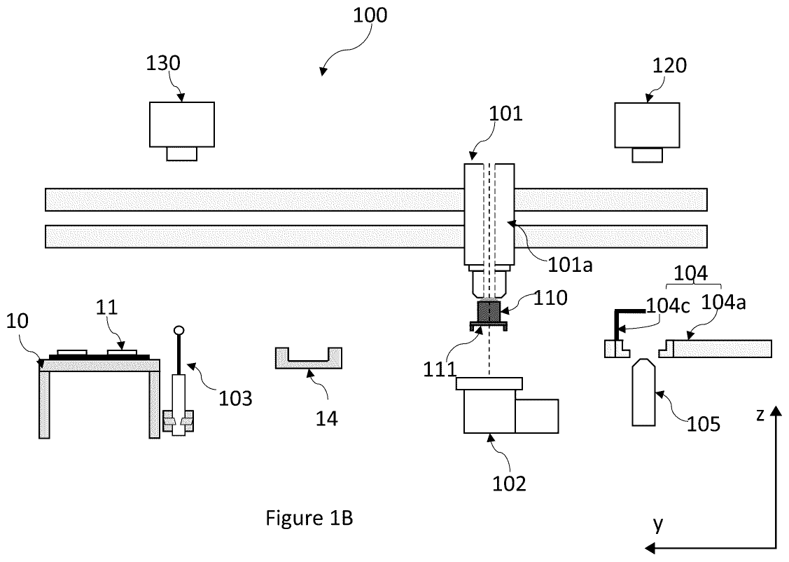

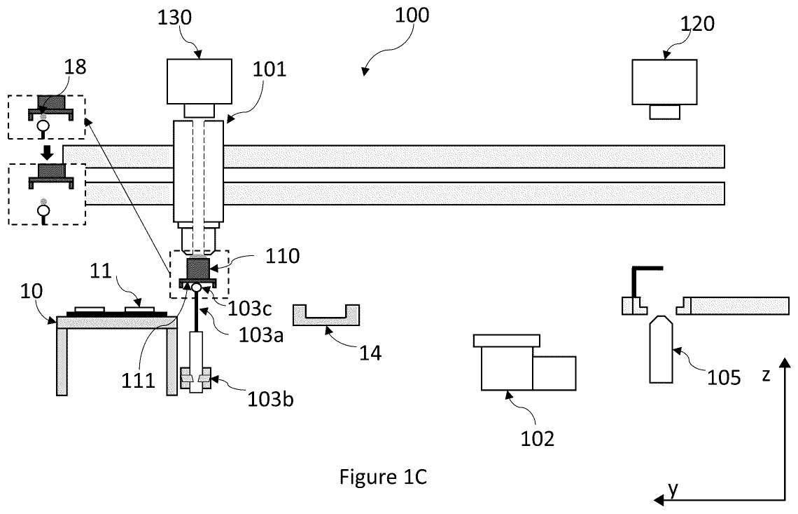

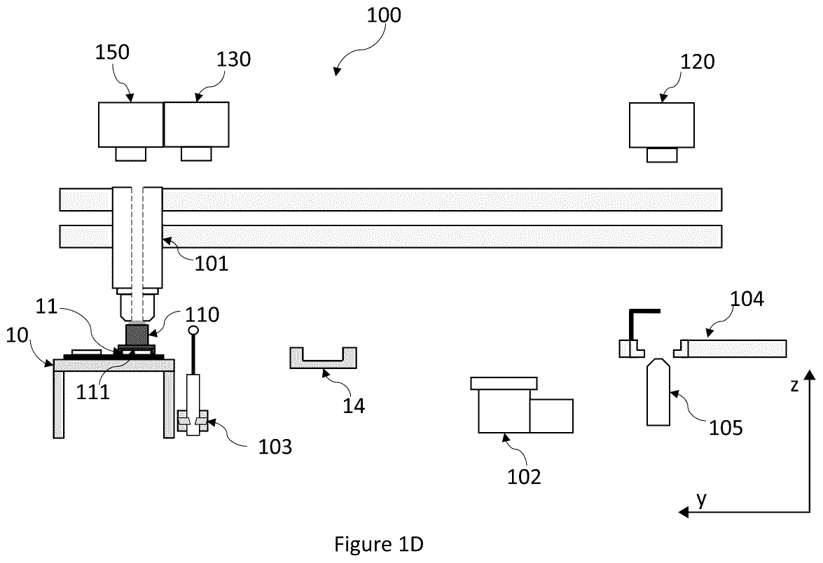

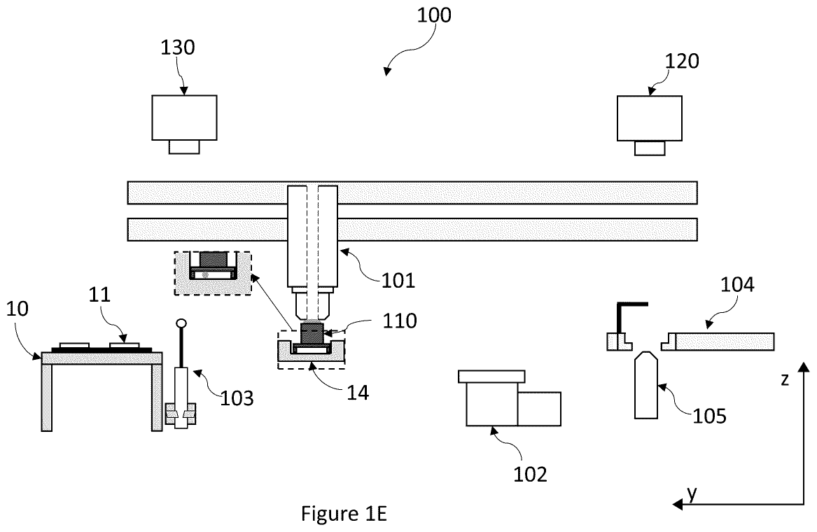

FIGS. 1A to 1E illustrate the steps of a method for removing foreign particles from a bonding surface 111 of a lens holder 110 with a system 100 according to one embodiment of the invention. A side view of the system 100 is shown in FIGS. 1A to 1E.

The system 100 includes a movable picking device 101, a vision system 102, a particle removal tool 103 and a pick-up station 104. The movable picking device 101 includes a bond head 101a having an opening comprising a hollow through-hole 101b along a longitudinal axis of the bond head 101a. The bond head 101a is movably installed on a motion gantry 101c to allow the bond head 101a to move along x-axis, y-axis, and z-axis directions. The vision system 102 is an up-look vision system that includes an up-look optical device to inspect a bonding surface 111 of a lens holder 110 when it is held by the picking device 101 to identify whether any foreign particles are present on the bonding surface 111. The particle removal tool 103 includes a gel stick 103a and a stick gripper 103b for releasably gripping the gel stick 103a to arrange a sticky tip portion 103c of the gel stick 103a to be facing upwards. The particle removal tool 103 is located so as to be able to contact each foreign particle present on the bonding surface 111 of the lens holder 110 with the sticky tip portion 103c to remove the foreign particle from the bonding surface 111 before the lens holder 110 is conveyed to a bonding station 10 by the picking device 101 to bond the lens holder 110 to a CMOS sensor 11 that is arranged on the bonding station 10.

The pick-up station 104 includes a supporting table 104a for supporting the lens holder 110. The supporting table 104a has an opening 104b with a hollow through-hole structure. The opening 104b includes an upper part which is sized and shaped to receive a bottom portion of the lens holder 110 and a lower part which is sized and shaped to prevent the lens holder 110 from passing through the opening 104b. The opening 104b is provided to expose the bonding surface 111 of the lens holder 110 to a cleaning device 105. The cleaning device 105 is located directly below the opening 104b of the supporting table 104a for applying a fluid to the bonding surface 111 to remove the foreign particles on the bonding surface 111. The pick-up station 104 may further include a clamping mechanism 104c for firmly securing the lens holder 110 in place during the cleaning process that is conducted by the cleaning device 105.

The system 100 may further include a first down-look optical system 120 which is located above the pick-up station 104 for aligning the picking device 101 and the lens holder 110 which is supported by the supporting table 104a. The first down-look optical system 120 may be operative to identify the position of the lens holder 110 through the hollow through-hole 101b of the picking device 101, so that the picking device 101 is movable relative to the position of the lens holder 110 to pick up the lens holder 110 from the pick-up station 104.

The system 100 may further include a second down-look optical system 130 which is located above the particle removal tool 103 for positioning the foreign particles on the bonding surface 111 of the lens holder 110 that is held by the picking device 101 relative to the sticky tip portion 103c of the gel stick 103a. The second down-look optical system 130 is also configured to inspect the position of the sticky tip portion 103c of the gel stick 103a.

The system may further include a reject bin 14 for storing rejected lens holders with bonding surfaces that fail to satisfy cleanliness requirements for the subsequent bonding process even after the particle removal process.

The steps for removing foreign particles from the bonding surface 111 of the lens holder 110 using the system 100 will be described below in detail with reference to FIGS. 1A to 1E.

### Passive Cleaning Using a Fluid

Referring to FIG. 1A, before conducting a passive cleaning process, the lens holder 110 is arranged on the pick-up station 104 such that the bottom portion of the lens holder 110 is received by the upper part of the opening 104b and the bonding surface 111 of the lens holder 110 is facing downwards. Thus, the bonding surface 111 is exposed through the lower part of the opening 104b to the cleaning device 105. Once the clamping mechanism 104c has been employed to secure the lens holder 110, the cleaning device 105 is activated to apply a fluid onto the bonding surface 111 to remove foreign particles present thereon. The fluid may include air, ionized air, or plasma. Upon the completion of the cleaning process involving the fluid, the cleaning device 105 may be additionally triggered to gather the removed foreign particles, utilizing an air suction function. The clamping mechanism 104c is then engaged to release the lens holder 110 in preparation for the subsequent step.

### Foreign Particle Inspection on the Bonding Surface

Referring to FIG. 1B, after picking up the lens holder 110 from the pick-up station 104, the picking device 101 holds the lens holder 110 with the bonding surface 111 facing downwards and moves to a predetermined inspection position to align with the vision system 102 that is located immediately below the inspection position. The vision system 102 is an up-look vision system that includes an up-look optical device that is operated to inspect the bonding surface 111 to identify whether any foreign particles are present on the bonding surface 111 and to determine positions of the foreign particles on the bonding surface 111. The position of each foreign particle on the bonding surface 111 may be represented by coordinate values (X, Y, Z) in a three-dimensional Cartesian coordinate system. Specifically, the vision system 102 may be operated to find out the number and sizes of foreign particles on the bonding surfaces 111. During the inspection process, the vision system 102 may adjust its light source to enhance the contrast between the foreign particles and the background of the bonding surface 111, thereby facilitating the inspection of the foreign particles.

### Particle Removal Process

Referring to FIG. 1C, after the inspection of the foreign particles on the bonding surface 111 has been completed, the picking device 101 holding the lens holder 110 moves to a cleaning position for removing the foreign particles with the particle removal tool 103. The particle removal tool 103 in this embodiment is fixedly located at the cleaning position with its sticky tip portion 103c facing upwards. To remove the foreign particles on the bonding surface 111 that have been identified during the inspection process, the picking device 101 is controllable to perform the following process:

Step 1: the picking device 101 moves along the X-axis and/or Y-axis directions to align a foreign particle on the bonding surface 111 with the sticky tip portion 103c of the gel stick 103a of the particle removal tool 103 based on the determined position of the foreign particle.

Before aligning the foreign particle with the sticky tip portion 103c, the second down-look optical system 130 may be operative to inspect the position of the sticky tip portion 103c of the particle removal tool 103. The position of the sticky tip portion 103c may include its horizontal position and elevation relative to the second down-look optical system 130. The position of the sticky tip portion 103c may be represented by coordinate values (x, y, z) in the same three-dimensional Cartesian coordinate system used for locating the foreign particles on the bonding surface.

Step 2: the picking device 101 moves downwards to the cleaning position along the Z-axis direction to contact the foreign particle 18 with the sticky tip portion 103c of the gel stick 103a to remove the foreign particle from the bonding surface 111.

Step 3: the picking device 101 moves upwards along the Z-axis direction after the foreign particle 18 has been removed.

Step 4: the picking device 101 repeats steps 1 to 3 until all the identified foreign particles have been removed from the bonding surface 111.

It should be noted that steps 1-3 are provided for illustrative purposes only. In other embodiments, the picking device 101 may move along various paths, as long as it enables the foreign particle on the bonding surface 111 to make contact with the sticky tip portion 103c of the gel stick 103a to remove the foreign particle from the bonding surface 111.

### Post-Cleaning Inspection

After the identified foreign particles have been removed, the picking device 101 may return to the position as shown in FIG. 1B to conduct a post-cleaning inspection on the bonding surface 111 with the vision system 102. In this step, the vision system 102 conducts post-cleaning inspection on the bonding surface 111 to determine whether the bonding surface 111 meets predetermined cleaning requirements before undergoing a subsequent bonding process. The predetermined cleaning requirements may include requirements concerning number and/or size thresholds of the foreign particles that might still be present on the bonding surface 111 after cleaning.

If post-cleaning inspection shows that the bonding surface 111 satisfies the predetermined cleaning requirements, the vision system 102 may be operative to conduct a position alignment between the lens holder 110 and the vision system 102. Specifically, the center of the lens holder 110 is aligned with the center of the vision system 102 by moving the bond head 101a of the picking device 101. After the position alignment of the lens holder 110 relative to the vision system 102 referring to FIG. 1D, the picking device 101 moves to the bonding station 10 and places the lens holder 110 onto a CMOS sensor 11 to bond the lens holder 110 to the CMOS sensor 11. A separate bonding optical system 150 may be used to inspect the position of the CMOS sensor 11 and conduct position alignment between the CMOS sensor 11 and the lens holder 110 before the lens holder 110 is placed onto the CMOS sensor 11.

If the post-cleaning inspection shows that the bonding surface 111 fails to meet the predetermined cleaning requirements, referring to FIG. 1E, the picking device 101 may transfer the rejected lens holder 110 to the reject bin 14 for recycling. Alternatively, the picking device 101 may move the lens holder 110 back to the cleaning position to conduct a second cleaning process based on the results of the post-cleaning inspection and repeat the post-cleaning inspection after the second cleaning process if the predetermined cleaning requirements can be satisfied.

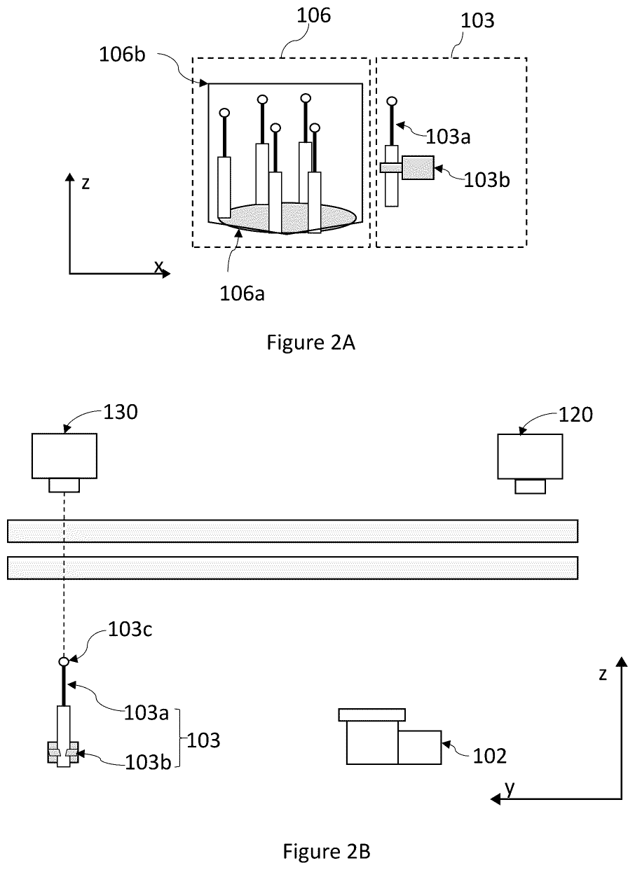

FIG. 2A is a side view of a gel stick station 106 according to one embodiment of the invention. The gel stick station 106 includes a rotatable container 106a for holding a plurality of replacement gel sticks and a cover 106b for removably covering the container 106a to prevent contamination of the gel sticks stored therein. In one example, the rotatable container 106a may include a carousel that includes receiving slots shaped and sized to receive and hold the plurality of gel sticks with their sticky tip portions facing upwards. The slots may extend radially and are located circumferentially around the carousel. When required, the stick gripper 103b of the particle removal tool 103 is operative to return a used gel stick 103a to the gel stick holder 106, e.g., by inserting the used gel stick 103a into a designated receiving slot of the rotatable container 106a. Thereafter, the stick gripper 103b would pick up a new gel stick from the gel stick holder 106 for a subsequent cleaning process by gripping it. To ensure a correct position of the gel stick 103a at the cleaning station, the second down-look optical system 130 may be used to view the position of the sticky tip portion 103c of the gel stick 103a as shown in FIG. 2B, to set a reference position for subsequent particle removal processes. Consequently, when substituting the gel stick 103a with a new one, the stick gripper 103b is operative to adjust the position of the new gel stick in accordance with the preset reference position. Specifically, the stick gripper 103b moves the new gel stick to the reference position. The second down-look optical system 130 may be further operative to inspect the sticky tip portion of the new gel stick to accurately determine the position of the sticky tip portion of the new gel stick. Accordingly, any positional offset of the sticky tip portion of the new gel stick relative to the reference position will be inspected by the second down-look optical system 130 and compensated by the movement of the picking device 101.

During the particle removal process, the vision system 102 and the second down-look optical system 130 will be used for inspection and alignment respectively. To enhance the accuracy of inspection or alignment, it is preferable to conduct calibration before these systems are used. An exemplary calibration process will be explained in detail below.

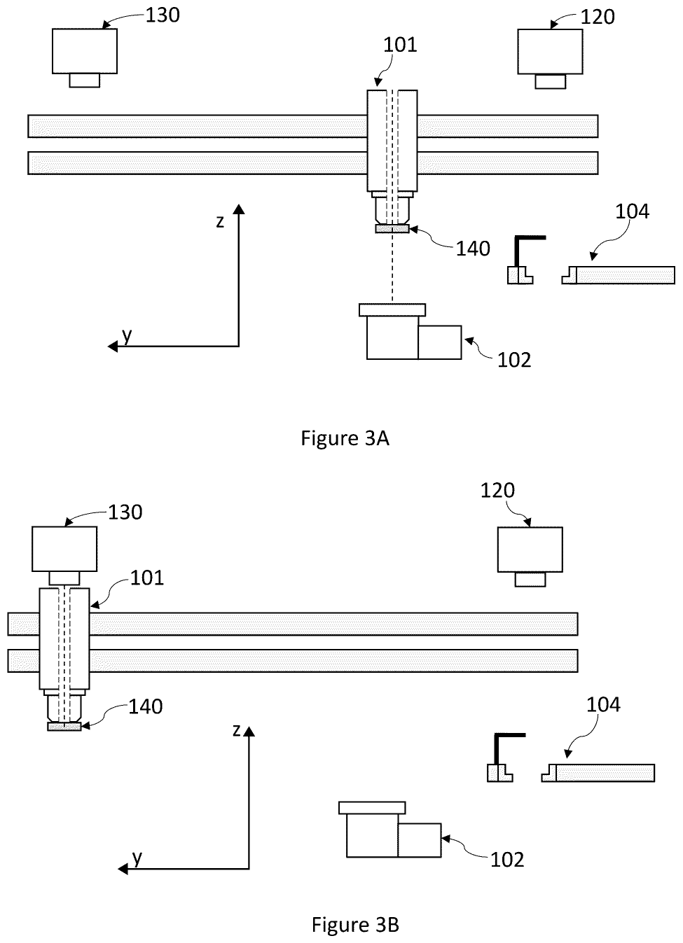

FIG. 3A illustrates the calibration between the picking device 101 and the vision system 102 for inspecting the bonding surface 111 of the lens holder 110 that is held by the picking device 101 according to one embodiment of the invention. The calibration process includes the following steps:

Step 1a: the picking device 101 picks up a calibration glass 140 and moves to the inspection position above the vision system 102. The calibration glass 140 may be supported by the pick-up station 104 and the picking device 101 would pick it from the pick-up station 104.

Step 2a: the vision system 102 inspects and identifies a known pattern on the calibration glass 140 and analyses an image of the calibration glass 140 including the known pattern as a reference image.

Step 3a: the picking device 101 moves predetermined distances relative to the inspection position or the vision system 102 along predetermined directions in order to position the known pattern at certain locations as viewed by the vision system 102. After each movement of the picking device 101, the vision system 102 inspects the known pattern and analyses an image of the calibration glass 140 to monitor and ascertain positional changes of the known pattern caused by the movement of the picking device 101. The positional changes of the known pattern are determined by comparing the images viewed and the reference image of the calibration glass 140. Based on the positional changes of the known pattern, a positional relationship between a position of an object held by the picking device 101 and an encoder position of the picking device 101 can be mapped for accurately identifying foreign particles on the bonding surface 111.

FIG. 3B illustrates a calibration process conducted between the picking device 101 and the second down-look optical system 130 for removing foreign particles from the bonding surface 111 with the particle removal tool 103 according to one embodiment of the invention. The calibration process includes the following steps:

Step 1b: the picking device 101 picks up the calibration glass 140 and moves to a position directly below the second down-look optical system 130. The calibration glass 140 may be picked up by the picking device 101 from the pick-up station 104.

Step 2b: the second down-look optical system 130 inspects and identifies the known pattern on the calibration glass 140 and records an image of the calibration glass 140 including the known pattern as a reference image.

Step 3b: the picking device 101 moves predetermined distances relative to the second down-look optical system 130 along predetermined directions. After each movement of the picking device 101, the second down-look optical system 130 inspects the known pattern and analyses the viewed image of the calibration glass 140 to monitor and ascertain positional changes of the known pattern caused by the corresponding movement of the picking device 101. The positional changes of the known pattern are determined by comparing the viewed images with the reference image of the calibration glass 140. Based on the positional changes of the known pattern, a positional relationship between a position of an object that is held by the picking device 101 and a position of the picking device 101 at the cleaning station can be mapped for accurately aligning the foreign particles on the bonding surface 111 with the sticky tip portion of the particle removal tool 103.

As will be appreciated from the above description, embodiments of the invention provide an automated method and system for removing foreign particles from a bonding surface of an object which is arranged facing downwards. With the method and system, any foreign particles on the bonding surface are first identified by an up-look vision system at an inspection position before the foreign particles are removed by a particle removal tool by contacting each of the foreign particles with the particle removal tool based on positions of the foreign particles identified by the up-look vision system. Since removal of the foreign particles is conducted based on the determined position of each foreign particle, the performance of the cleaning process can be significantly improved. Since the particle removal tool has a sticky tip portion that is arranged facing upwards, the picking device is effective in positioning each foreign particle on the bonding surface with respect to the sticky tip portion during the particle removal process. Furthermore, a post-cleaning inspection on the bonding surface may be conducted by the up-look vision system to check whether the cleaned bonding surface satisfies a predetermined cleaning requirement for the subsequent bonding process, thereby improving the yield rate of the subsequent bonding process. Additionally, a passive cleaning process may be conducted using a cleaning device located at the pick-up station before the object is picked up by the picking device, to further improve the efficiency of the foreign particle removal process.

Although the present invention has been described in considerable detail with reference to certain embodiments, other embodiments are possible. Therefore, the spirit and scope of the appended claims should not be limited to the description of the embodiments contained herein.

1. A method for removing foreign particles from an object having a bonding surface, the method comprising:
arranging the object at a pick-up station and picking up the object with a movable picking device with the bonding surface of the object facing downwards;
moving the object to an inspection position with the movable picking device and inspecting the bonding surface with a vision system located below the inspection position to identify whether any foreign particles are present on the bonding surface and to determine positions of the foreign particles on the bonding surface, and
contacting each foreign particle with a particle removal tool at the determined position of the respective foreign particle in order to remove it when the bonding surface is facing downwards.

2. The method according to claim 1, further comprising: conducting post-cleaning inspection on the bonding surface with the vision system to determine whether the bonding surface meets a predetermined cleaning requirement before undergoing a subsequent bonding process.

3. The method according to claim 2, further comprising: transferring the object to a reject bin if the bonding surface does not meet the predetermined cleaning requirement.

4. The method according to claim 2, further comprising: transferring the object with the movable picking device to a bonding station for bonding if the bonding surface meets the predetermined cleaning requirement.

5. The method according to claim 1, further comprising: applying a fluid with a cleaning device to the bonding surface of the object to remove foreign particles on the bonding surface before the object is picked up by the movable picking device.

6. The method according to claim 1, further comprising: aligning the movable picking device with the object when the object is positioned on a pick-up station using a first optical system located above the pick-up station, prior to picking up the object with the movable picking device.

7. The method according to claim 1, further comprising: aligning each foreign particle on the bonding surface of the object held by the picking device relative to a sticky tip portion of the particle removal tool using a second optical system located above the particle removal tool, prior to removing the foreign particle.

8. The method according to claim 7, further comprising: replacing the particle removal tool with a new particle removal tool and adjusting a position of the new particle removal tool using the second optical system based on a predetermined reference position of the particle removal tool.

9. The method according to claim 7, further comprising: identifying a known pattern on a calibration object that is held by the movable picking device with the second optical system, monitoring and ascertaining positional changes of the known pattern as the movable picking device moves to a plurality of predetermined positions relative to the second optical system and mapping a relationship between positions of the object relative to positions of the movable picking device based on the ascertained positional changes.

10. The method according to claim 1, further comprising: identifying a known pattern on a calibration object that is held by the movable picking device with the vision system, monitoring and ascertaining positional changes of the known pattern as the movable picking device moves relative to the vision system and mapping a relationship between positions of the object relative to positions of the movable picking device based on the ascertained positional changes.

11. The method according to claim 10, wherein the calibration object includes a transparent material on which the known pattern is formed.

12. The method according to claim 1, wherein the movable picking device comprises a bond head having an opening comprising a hollow through-hole along its longitudinal axis.

13. The method according to claim 1, wherein the vision system includes an up-look optical device.

14. The method according to claim 1, wherein the particle removal tool includes a gel stick having a sticky tip portion facing upwards.

15. The method according to claim 1, wherein the object includes a lens holder supporting a lens that is to be bonded to an image sensor.

16. The method according to claim 15, further comprising: conducting a position alignment between the lens holder and the vision system with the vision system after removing the foreign particles from the bonding surface of the object.

17. A system for removing foreign particles from an object having a bonding surface, the system comprising:
a pick-up station on which the object is arranged,
a movable picking device configured and operative to pick up the object from the pick-up station with the bonding surface of the object facing downwards and to move the object to an inspection position,
a vision system located below the inspection position to inspect the bonding surface to identify whether any foreign particles are present on the bonding surface and to determine positions of the foreign particles on the bonding surfaces, and
a particle removal tool configured to contact each foreign particle on the bonding surface at the determined position of the respective foreign particle to remove it from the bonding surface while the bonding surface is facing downwards.

18. The system according to claim 17, wherein the movable picking device includes a bond head having an opening comprising a hollow through-hole along a longitudinal axis of the bond head.

19. The system according to claim 17, wherein the vision system includes an up-look optical system, which is further configured to conduct a position alignment between the lens holder and the vision system.

20. The system according to claim 17, wherein the particle removal tool includes a gel stick having a sticky tip portion facing upwards.

21. The system according to claim 17, further comprising a particle removal tool holder configured to hold a plurality of particle removal tools, each particle removal tool being arranged such that a sticky tip portion thereof faces upwards.
